(19) United States
(12) Patent Application Publication
(10) Pub. No.: US 2006/0279895 A1
(43) Pub. Date: Dec. 14, 2006

(54) Lightning arrestor

(75) Inventors: Makoto Yamaguchi, Tokyo (JP); Shinji Ishibe, Tokyo (JP); Mitsunori Hama, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/448,775

(22) Filed: Jun. 8, 2006

(30) Foreign Application Priority Data
Jun. 10, 2005 (JP) 2005-170353

(51) Int. Cl. H02H 9/06

(52) U.S. Cl. 361/118

(57) ABSTRACT

A lightning arrestor is obtained, which is excellent in pressure relief performance and can be reduced in manufacturing cost while securing bending strength necessary for a lightning arrestor. A plurality of eaves-trough-like insulators 2 having arcuate sections enclosing zinc oxide elements 1 are arranged around the zinc oxide elements 1 to form a common cylindrical construct TA enclosing the zinc oxide elements 1, and the plurality of eaves-trough-like insulators 2 are provided with a predetermined interval to one another in a circumferential direction of the cylindrical construct TA, and both ends of the plurality of eaves-trough-like insulators 2 are fixed to terminal portions 6A, 6B provided at both ends of the zinc oxide elements 1, respectively.

### BACKGROUND OF THE INVENTION

1. Field of the Invention

The present invention relates to a lightning arrestor, and particularly relates to a lightning arrestor in which a plurality of zinc oxide elements are stacked, which are to be protected from abnormal voltage such as opening-and-closing surge or lightning surge generated in a circuit of an electric equipment connected to an electric system, and an insulating member formed of an insulating member such as silicone rubber or silicone polymer is covered around the elements as an armor.

2. Description of the Related Art

As a structure of the lightning arrestor in the related art, in which the insulating member formed of the insulating member such as silicone rubber or silicone polymer is covered around the zinc oxide elements as the armor, two types are given in rough classification. That is, two types of structures including a structure where the peripheries of the zinc oxide elements are covered by an insulating cylinder (for example, refer to patent literature 1 and patent literature 2), and a structure where several platelike insulators (for example, FRP) are disposed around the zinc oxide elements (for example, refer to patent literature 3) are given (hereinafter, the former is called insulating cylinder type, and the latter is called insulating plate type).

These lightning arrestors are common in that the insulating cylinder or the platelike insulators is/are disposed around the stacked zinc oxide elements, and the insulating cylinder or the platelike insulators is/are fixed using screws and the like at electrodes placed in both ends of the zinc oxide elements, however, essentially different in pressure relief mechanism of the lightning arrestor. In the insulating cylinder type, circular, elliptical, or slit-like holes or reduced thickness portions are provided in an outer circumferential portion of the insulating cylinder, and such hole portions are designed to have capability for promptly relieving internal pressure generated in the unlikely event that a short-circuit current flows through the lightning arrestor, on the other hand, in the insulating plate type, the insulating plates are disposed with being spaced from each together, and the internal pressure is relieved through spaces among them.

[Patent literature 1]

JP-A-2003-397608 (FIGS. 2 to 4 and p. 3).

[Patent literature 2]

JP-A-6-139858 (FIGS. 1 to 2 and p. 3).

[Patent literature 3]

JP-A-2001-291606 (FIGS. 1 to 2 and pp. 4 to 6).

### SUMMARY OF THE INVENTION

In the case of the insulating cylinder type, the lightning arrestor has high mechanical strength against bending necessary for a lightning arrestor, and relieves pressure applied to inner faces of the insulating cylinder during relieving the internal pressure of the lightning arrestor from the hole portions provided in the outer circumferential face of the insulating cylinder to reduce the pressure, thereby prevents explosive scattering, and consequently the lightning arrestor is excellent in pressure relief performance. However, the lightning arrestor has a disadvantage of high manufacturing cost because the insulating cylinder is subjected to processing for making the cylinder into a complicated shape. In particular, since manufacturing cost depends on thickness of the insulating cylinder, there is a difficulty that when thickness of the insulating cylinder is excessively increased to improve the mechanical strength or pressure relief performance, manufacturing cost of the insulating cylinder itself is extremely increased.

On the other hand, in the case of the insulating plate type, while manufacturing cost is low, there is a difficulty that mechanical strength against bending is inferior compared with the insulating cylinder type. Therefore, in the case that internal pressure of the lightning arrestor is increased, when excessive force is loaded to the insulating plates, in the worst case, the insulating plates may be broken, or may be blown off together with the screws fixing the insulating plates. When thickness of the insulating plates is increased to prevent this, manufacturing cost is accordingly increased, and consequently low manufacturing cost as the largest merit in the case of using the insulating plate can not be drawn.

In this way, while each of the insulating cylinder type and the insulating plate type has one of merits in respect of the mechanical strength and the manufacturing cost, both conditions of improvement in mechanical strength and low manufacturing cost have been hardly satisfied.

It is desirable to obtain a lightning arrestor that is excellent in pressure relief performance and can be reduced in manufacturing cost while securing bending strength necessary for a lightning arrestor.

In a lightning arrestor according to an embodiment of the invention, a plurality of insulating members having arcuate sections enclosing nonlinear elements are arranged around the nonlinear elements to form a common cylindrical construct provided enclosing the nonlinear elements, and the plurality of insulating members are provided with a predetermined interval to one another in a circumferential direction of the cylindrical construct, and both ends of the plurality of insulating members are fixed to both ends of the nonlinear elements respectively.

Advantage of the Invention

According to the embodiment of the invention, the lightning arrestor can be obtained, which is excellent in pressure relief performance and can be reduced in manufacturing cost while securing the bending strength necessary for a lightning arrestor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a longitudinal section view showing a general configuration of a lightning arrestor of an embodiment 1 according to the invention;

FIG. 2 is a schematic view showing a configuration of eaves-trough-like insulators formed by cutting out a portion of an insulating cylinder, which shows a configuration of the embodiment 1 according to the invention;

FIGS. 3A to 3C show lateral section views when the eaves-trough-like insulators of the embodiment 1 according to the invention are disposed around zinc oxide elements;

FIG. 4 is a lateral section view showing a configuration of the embodiment 1 according to the invention, which indicates means for fixing the eaves-trough-like insulators at electrode portions;

FIGS. 5A to 5C are lateral section views schematically indicating an aspect of relieving gas with increased pressure through spaces between the eaves-trough-like insulators of the embodiment 1 according to the invention;

FIGS. 6A to 6C are lateral section views describing that the space between the eaves-trough-like insulators of the embodiment 1 according to the invention is constant irrespective of the number of the eaves-trough-like insulators;

FIG. 7 is a schematic view showing a configuration of eaves-trough-like insulators formed by cutting out a portion of an insulating cylinder, which shows a configuration of an embodiment 2 according to the invention;

FIG. 8 is a schematic view showing a configuration of eaves-trough-like insulators formed by cutting out a portion of an insulating cylinder, which shows a configuration of an embodiment 3 according to the invention; and

FIG. 9 is a schematic view showing a configuration of eaves-trough-like insulators formed by cutting out a portion of an insulating cylinder, which shows a configuration of an embodiment 4 according to the invention.

### DESCRIPTION OF THE PREFERRED EMBODIMENT

Embodiment 1

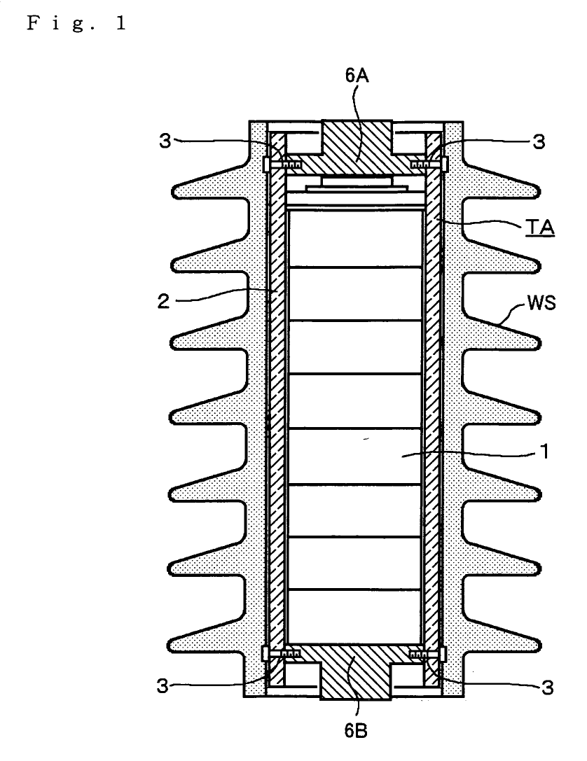

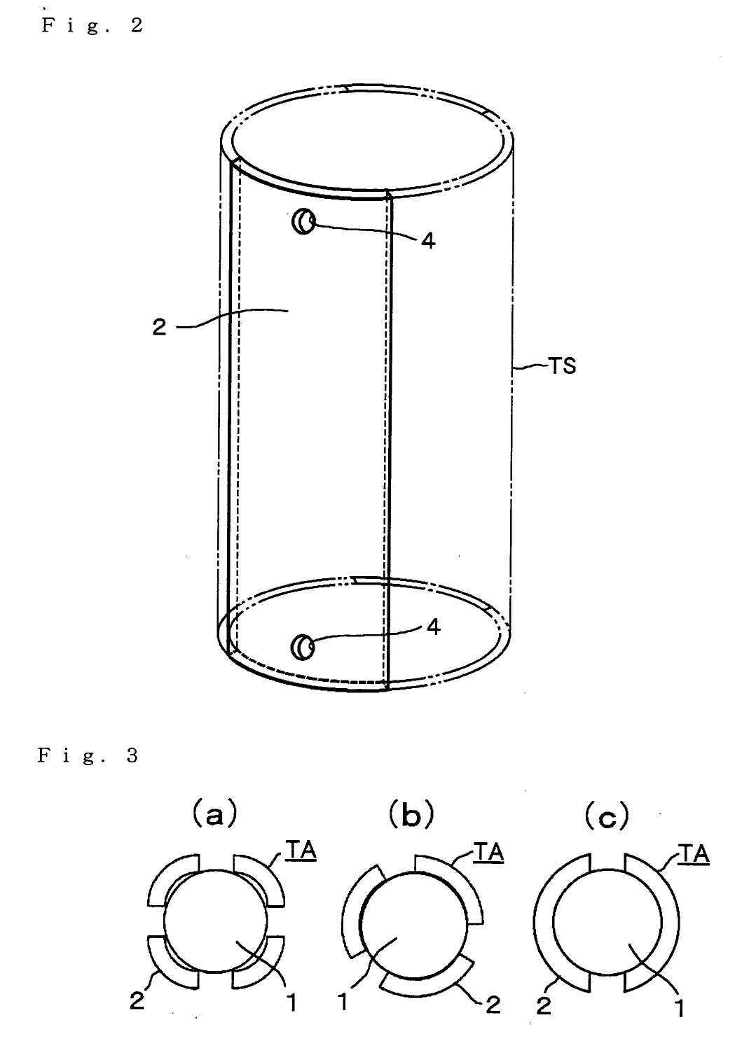

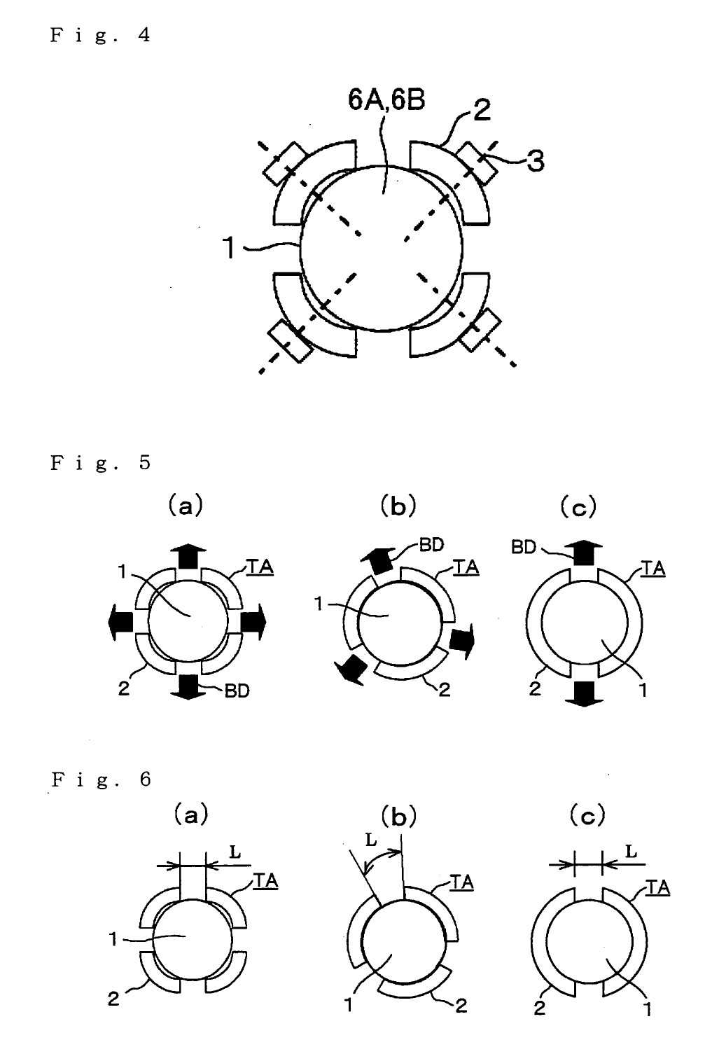

An embodiment 1 according to the invention is described with regard to FIGS. 1 to 6C. FIG. 1 is a longitudinal section view showing a general configuration of a lightning arrestor of the embodiment 1. FIG. 2 is a schematic view of an eaves-trough-like insulator formed by cutting out a portion of an insulating cylinder, which shows a configuration of the embodiment 1. FIGS. 3A to 3C show lateral section views when the eaves-trough-like insulators shown in the embodiment 1 are disposed around zinc oxide elements. FIG. 4 is a lateral section view showing a configuration of the embodiment 1, which indicates means for fixing the eaves-trough-like insulators at electrode portions. FIGS. 5A to 5C are lateral section views schematically indicating an aspect of relieving gas with increased pressure through spaces among the eaves-trough-like insulators of the embodiment 1. FIGS. 6A to 6C are lateral section views describing that the space between the eaves-trough-like insulators of the embodiment 1 is constant irrespective of the number of the eaves-trough-like insulators.

FIG. 1 shows the general configuration of the lightning arrestor of the embodiment 1 according to the invention, wherein nonlinear elements formed of zinc oxide elements 1 as negative nonlinear resistance elements are covered with (but chemically bonded to) a molding material such as silicone rubber or silicone polymer in a form of being accommodated in a weather resistance container WS configured by the molding material such as silicone rubber or silicone polymer. A plurality of eaves-trough-like insulators 2 are arranged between the zinc oxide elements 1 and the molding material such as silicone rubber or silicone polymer forming the weather resistance container WS.

Both ends of the eaves-trough-like insulators 2 are fixed to terminal portions 6A and 6B provided at both ends of the zinc oxide elements 1 by screws 3.

FIG. 2 shows a shape of an insulator including the eaves-trough-like insulator 2 of the embodiment 1 according to the invention, wherein the insulator including the eaves-trough-like insulator 2 is originally produced as an insulating cylinder TS shown by a virtual line using a two-dot chain line, and the cylinder is divided evenly in an axial direction, that is, divided with constant width into the eaves-trough-like insulators 2.

As shown in FIGS. 3A, 3B and 3C, the number of division is set to be 2 to 4, which is properly used depending on the diameter of the zinc oxide element 1 to be used. For example, when an element having a small diameter is used, a small division number is used, and when an element having a large diameter is used, a large division number is used.

Hole portions 4 are provided in two places on an outer circumferential portion of the eaves-trough-like insulator 2 near both ends of the insulator. The hole portions 4 are used for fixing the eaves-trough-like insulator 2. That is, the eaves-trough-like insulators 2 are disposed around the zinc oxide elements 1, and the eaves-trough-like insulators 2 are fixed using screws 3 at electrode portions 6A, 6B disposed at both ends of the zinc oxide elements 1. An aspect of such fixation is shown in FIG. 4.

The eaves-trough-like insulators 2 are disposed around the zinc oxide elements 1. As shown in FIGS. 5A to 5C, internal pressure generated in the unlikely event that a short-circuit current flows within the lightning arrestor is promptly relieving through spaces between the insulators in order to prevent jumping of internal components of the lightning arrestor including the zinc oxide elements 1 to the outside, or occurrence of explosive scattering.

FIG. 5A shows a relief direction BD of internal pressure when four eaves-trough-like insulators 2 are given, FIG. 5B shows the direction when three eaves-trough-like insulators 2 are given, and FIG. 5C shows the direction when two eaves-trough-like insulators 2 are given.

When the internal pressure is increased, force of pushing the eaves-trough-like insulators 2 to the outside is applied, and thereby excessive load is applied to the screws 3, therefore the eaves-trough-like insulators 2 need to be securely fixed. Thus, inner diameters of the eaves-trough-like insulators 2 are designed to be conformed to an outer diameter of the zinc oxide element 1 to enhance adhesion.

While an interval of the eaves-trough-like insulators 2 may be optionally set, as shown in FIG. 6, an interval L is made to be constant irrespective of the number of the eaves-trough-like insulators 2 to be used to prevent pressure relief performance from being varied with respect to expected performance by changing the number of the eaves-trough-like insulators 2. As a result of a pressure relief test, it is confirmed that the interval L is preferably about 10 mm to 20 mm. When the number of the eaves-trough-like insulators 2 is increased, since the required interval L can not be secured, width of the eaves-trough-like insulators 2 is reduced.

In the embodiment 1 according to the invention, while cost necessary for processing is increased because the eaves-trough-like insulators 2 are produced by cutting out from the insulating cylinder TS, the eaves-trough-like insulators 2 are disposed with the interval, thereby weak portions need not be provided on the eaves-trough-like insulators 2 to relieve the gas with increased pressure, therefore processing cost for the insulating cylinder TS itself is eliminated, and consequently manufacturing cost can be relatively reduced. Moreover, since inner surfaces of the insulators are smooth along the diameters of the zinc oxide elements 1 unlike the insulating plates, the insulators are enhanced in adhesion to the zinc oxide elements 1, and easily fixed to the electrode portions 6A, 6B at both the ends of the zinc oxide elements 1, as a result mechanical strength against bending is increased compared with the insulating plates.

According to the embodiment 1 according to the invention, a plurality of insulating members including the eaves-trough-like insulators 2 having arcuate sections enclosing nonlinear elements including the zinc oxide elements 1 are arranged around the nonlinear elements including the zinc oxide elements 1 to form a common cylindrical construct TA, which is provided enclosing the nonlinear elements including the zinc oxide elements 1, and the plurality of insulating members including the eaves-trough-like insulators 2 are provided with a predetermined interval to one another in a circumferential direction of the cylindrical construct TA, and both ends of the plurality of insulating members including the eaves-trough-like insulators 2 are fixed to the terminal portions 6A, 6B provided at both end portions of the nonlinear elements including the zinc oxide elements 1 by clamping by the screws 3 respectively; therefore the lightning arrestor can be obtained, which is excellent in pressure relief performance and can be reduced in manufacturing cost while securing the bending strength necessary for a lightning arrestor.

Embodiment 2

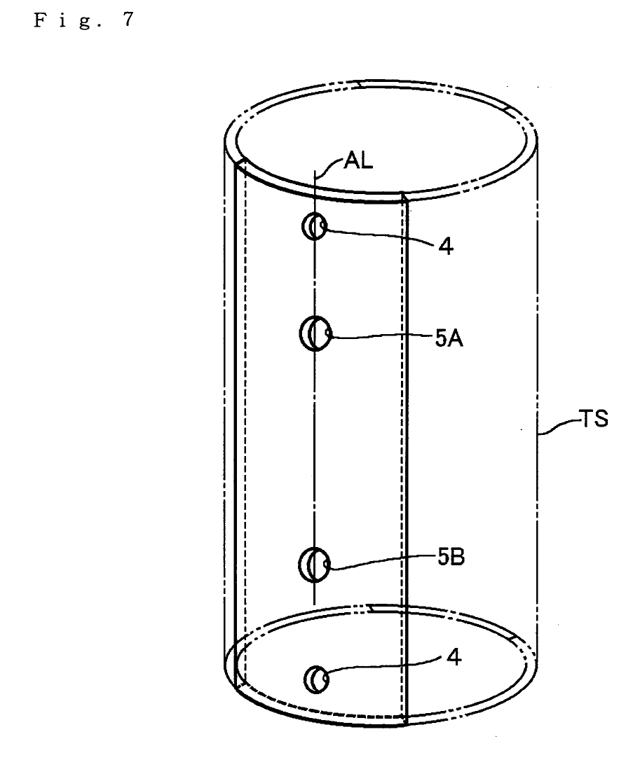

Embodiment 2 according to the invention is described with regard to FIG. 7. FIG. 7 is a schematic view showing a configuration of an eaves-trough-like insulator formed by cutting out a portion of the insulating cylinder in the embodiment 2.

The embodiment 2 has the same configurations as in the embodiment 1 described before with regard to configurations other than a specific configuration described herein and exhibits the same operation. In the figure, the same signs indicate equivalent or corresponding portions.

FIG. 7 shows the configuration of the eaves-trough-like insulator in the embodiment 2 according to the invention, which shows a configuration developed from the configuration of the embodiment 1. In addition to a structure of the embodiment 1, pressure relief holes 5A, 5B are provided in the eaves-trough-like insulator 2 separately from the holes 4 for fixing the eaves-trough-like insulator 2 in order to relieve the internal gas with increased pressure more smoothly and promptly. To facilitate processing of the pressure relief holes 5A, 5B and thus reduce the manufacturing cost, the pressure relief holes 5 have a round form, and the pressure relief holes 5A, 5B are provided on the same axis as that of the holes 4 for fixing the eaves-trough-like insulator 2 provided on an axis AL parallel to the central axis of the insulating cylinder TS.

According to the embodiment 2 according to the invention, in the configuration of the embodiment 1, the fixation holes 4 are provided at both ends of the plurality of insulating members including the eaves-trough-like insulators 2, and the pressure relief holes 5A, 5B are provided on the same axis AL as that of the fixation holes 4, therefore the lightning arrestor can be obtained, which is excellent in pressure relief performance and can be reduced in manufacturing cost while securing the bending strength necessary for a lightning arrestor.

Embodiment 3

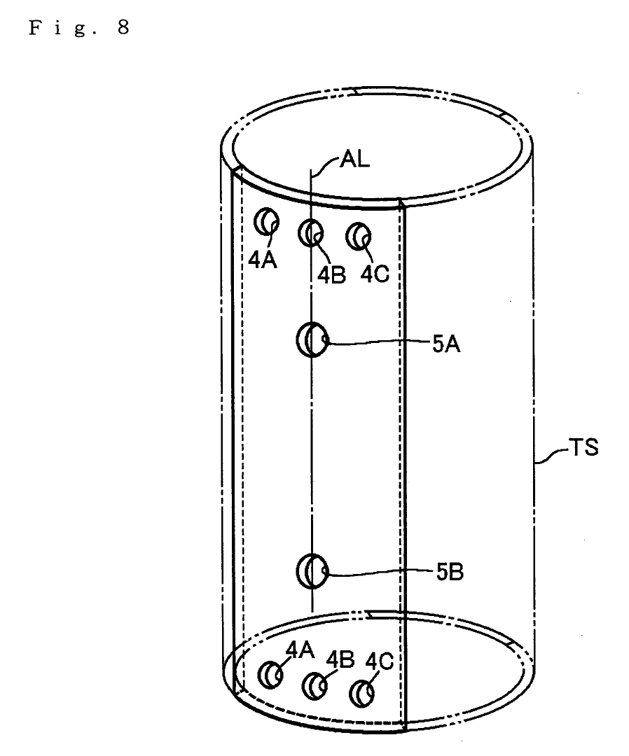

Embodiment 3 according to the invention is described with regard to FIG. 8. FIG. 8 is a schematic view showing a configuration of an eaves-trough-like insulator formed by cutting out a portion of an insulating cylinder in the embodiment 3.

The embodiment 3 has the same configurations as in the embodiment 2 described before with regard to configurations other than a specific configuration described herein and exhibits the same operation. In the figure, the same signs indicate equivalent or corresponding portions.

FIG. 8 shows the configuration of the eaves-trough-like insulator in the embodiment 3 according to the invention, which shows a modification of the embodiment 2 shown in FIG. 7.

When the number of cutout from the insulating cylinder TS is small, and consequently the number of the eaves-trough-like insulators 2 is small, since width of the eaves-trough-like insulator 2 is increased (the width is necessarily increased to keep the spaces between the eaves-trough-like insulators 2 constant), fixation of the eaves-trough-like insulators 2 may be necessary to be enhanced. In such a case, a plurality of holes for fixing the eaves-trough-like insulators 2 are provided. FIG. 8 shows an example where the holes are provided at, for example, three points in each of upper and lower portions as fixation holes 4A, 4B and 4C. Centers of the respective fixation holes 4A, 4B and 4C are disposed at an equal interval on the same line in the circumferential direction of the cylindrical body TS in the light of ease in processing. In the case of the embodiment, the pressure relief holes 5A, 5B are provided near a central portion of the three fixation holes 4A, 4B and 4C of the eaves-trough-like insulator 2, and provided on the same axis as that of the fixation hole 4B provided on the axis AL parallel to the central axis of the insulating cylinder TS.

According to the embodiment 3 according to the invention, in the configuration of the embodiment 2, the plurality of fixation holes 4A, 4B and 4C are provided at both ends of the plurality of insulating members including the eaves-trough-like insulators 2, and the pressure relief holes 5A, 5B are provided on the same axis AL as that of the fixation hole 4B in the fixation holes 4A, 4B and 4C, therefore the lightning arrestor can be obtained by reinforcing fixation portions, which is excellent in pressure relief performance and can be reduced in manufacturing cost while securing the bending strength necessary for a lightning arrestor.

Embodiment 4

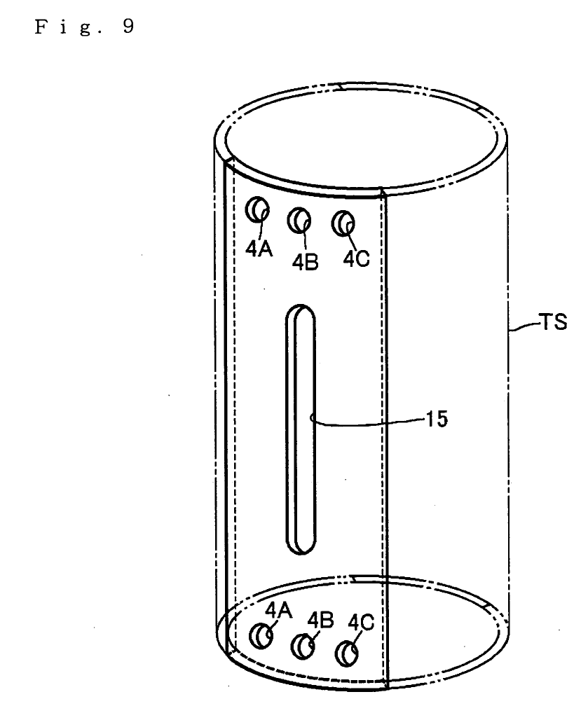

Embodiment 4 according to the invention is described with regard to FIG. 9. FIG. 9 is a schematic view showing a configuration of an eaves-trough-like insulator formed by cutting out a portion of an insulating cylinder in the embodiment 4.

The embodiment 4 has the same configurations as in the embodiment 3 described before with regard to configurations other than a specific configuration described herein and exhibits the same operation. In the figure, the same signs indicate equivalent or corresponding portions.

FIG. 9 shows the configuration of the eaves-trough-like insulator in the embodiment 4 according to the invention, which shows a modification of the embodiment 3 shown in FIG. 8.

In the embodiment 4, a form of the pressure relief holes 5A, 5B in the embodiment 3 shown in FIG. 8 is changed from a circle to an ellipse as shown in FIG. 9 as a pressure relief hole 15.

When structures described in the embodiments 1 to 3 are applied to a lightning arrestor used for low system voltage in the lightning arrestors in which the peripheries of the stacked zinc oxide elements 1 are covered with silicone rubber, silicone polymer or the like, a hole 5 for enhancing pressure relief capability is acceptable, however, when they are applied to a lightning arrestor used for high system voltage, the short-circuit current is typically increased compared with the low system voltage, and consequently generated internal pressure becomes large, therefore pressure needs to be relieving smoothly and promptly, and therefore relief area is desired to be increased. Therefore, the relief area was increased by changing the shape from the circle to the ellipse to improve the pressure relief capability.

According to the embodiment 4 according to the invention, in the configuration of the embodiment 2 or the embodiment 3, since the hole for enhancing pressure relief capability is formed in an elliptical form as the pressure relief hole 15 shown in FIG. 9, the lightning arrestor can be obtained, which is improved in pressure relief performance further securely and can be reduced in manufacturing cost while securing the bending strength necessary for a lightning arrestor.

In the embodiments of the invention, configurations described in the following sections (1) to (4) are proposed.

(1) The lightning arrestor in which the insulating cylinder TS is cut out severally in the axial direction to form the eaves-trough-like insulators 2, and then for each of the eaves-trough-like insulators 2, the holes 4 are opened at the points near the ends to allow the insulators to be fixed using the screws 3 at the electrode portions 6A, 6B placed at both ends of the stacked zinc oxide elements 1, and the eaves-trough-like insulators 2 are disposed with an appropriate interval to secure the necessary pressure relief performance.

(2) The lightning arrestor in which the pressure relief hole 5 are provided on the same axis as that of the fixation holes 4 separately from the holes 4 for fixing the eaves-trough-like insulators 2 to improve the pressure relief capability.

(3) The lightning arrestor in which the plurality of holes are provided for fixing the eaves-trough-like insulators 2, and the pressure relief holes 5 are provided on the same axis as that of the fixation holes 4 separately from the holes 4 for fixing the eaves-trough-like insulators 2.

(4) The lightning arrestor in which the holes 5 for relieving increased internal pressure are formed in an elliptical form rather than circular form to improve the pressure relief capability.

In the embodiment according to the invention, the insulating cylinder TS is cut out severally (about 2 to 4 depending on the diameter of the zinc oxide elements 1 to be used) in the axial direction to form the eaves-trough-like insulators 2. Then, the fixation holes 4 are opened at the places near the ends of the eaves-trough-like insulators 2 so that the insulators can be fixed at the electrode portions 6A, 6B placed at both ends of the stacked zinc oxide elements 1. Appropriate spaces are provided between the plurality of eaves-trough-like insulators 2 obtained by being cut out so that the internal pressure generated in the likely event that the short-circuit current flows within the lightning arrestor is promptly relieved through the spaces. To ensure fixation of the eaves-trough-like insulators 2, the inner diameters of the eaves-trough-like insulators 2 are designed to be conformed to the outer diameters of the zinc oxide elements 1 to enhance adhesion. To secure the necessary pressure relief performance, the interval L between the eaves-trough-like insulators 2 is set constant irrespective of the number of the eaves-trough-like insulators 2. Therefore, when the number of the eaves-trough-like insulators 2 is increased, the interval is adjusted by reducing the width of the eaves-trough-like insulators 2.

As a different method from the above, to improve the pressure relief capability, the pressure relief holes 5A, 5B are provided on a surface of the eaves-trough-like insulator 2 separately from the holes 4 for fixing the eaves-trough-like insulator 2. The pressure relief holes 5 are opened near the holes 4 for fixing the eaves-trough-like insulator 2 and on the same axis as that of the fixation holes 4. When the number of the eaves-trough-like insulators 2 is small, since width of the eaves-trough-like insulators 2 is increased, fixation may be necessary to be enhanced. Thus, a plurality of holes for fixing the eaves-trough-like insulator 2 are provided like the fixation holes 4A, 4B and 4C.

As another method, the above methods may be combined. That is, an example where when the number of the eaves-trough-like insulators 2 is small, the plurality of fixation holes 4A, 4B and 4C are provided for fixing the eaves-trough-like insulator 2, and the pressure relief holes 5A, 5B are provided on the surface of the eaves-trough-like insulator 2, and an example where the pressure relief holes 5A, 5B for relieving internal pressure is formed elliptically like the pressure relief hole 15 shown in FIG. 9 rather than circular aiming to effect of remarkably improving the pressure relief capability are given.

While the presently preferred embodiments of the present invention have been shown and described. It is to be understood that these disclosures are for the purpose of illustration and that various changes and modifications may be made without departing from the scope of the invention as set forth in the appended claims.

What is claimed is:

1. A lightning arrestor, wherein
a plurality of insulating members having arcuate sections enclosing nonlinear elements are arranged around the nonlinear elements to form a common cylindrical construct provided enclosing the nonlinear elements, and
the plurality of insulating members are provided with a predetermined interval to one another in a circumferential direction of the cylindrical construct, and
both ends of the plurality of insulating members are fixed to terminal portions provided at both ends of the nonlinear elements respectively.

2. The lightning arrestor according to claim 1,
wherein fixation holes are provided at both ends of the plurality of insulating members, and
pressure relief holes are provided on the same axis as that of the fixation holes.

3. The lightning arrestor according to claim 1,
wherein fixation holes are provided at both ends of the plurality of insulating members, and
pressure relief holes are provided on the same axis as that of the fixation holes.

4. The lightning arrestor according to claim 2, wherein a form of the pressure relief holes is an ellipse.

5. The lightning arrestor according to claim 3, wherein a form of the pressure relief holes is an ellipse.
